(19) United States
(12) Patent Application Publication
(10) Pub. No.: US 2006/0109680 A1
(43) Pub. Date: May 25, 2006

(54) Decorative light-transmission device

(76) Inventors: Chi-Tsung Peng, Hsinchu (TW); Kuo-Hsiang Wen, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/191,829

(22) Filed: Jul. 27, 2005

(30) Foreign Application Priority Data
Nov. 23, 2004 (TW) 93218772

(51) Int. Cl. F21S 6/00

(52) U.S. Cl. 362/565; 362/582

(57) ABSTRACT

A decorative light-transmission device includes a light source and a flexible light-transmission structure positioned adjacent to the light source and combined with an object to be decorated. The light-transmission structure receives and radiates the light from the light source, and the radiation of the light-transmission structure illuminates the object to be decorated.

### BACKGROUND OF THE INVENTION

a. Field of the Invention

The invention relates to a light-transmission device and, more particularly, to a decorative light-transmission device whose shape is adaptable in accordance with the shape of an object to be decorated for providing a decorative lighting effect.

b. Description of the Related Art

Conventionally, accessories such as key chains and hanging decorations are illuminated by two ways as described below.

Referring to FIG. 1, a plurality of light emitting diodes (LEDs) 100 are coupled to a wire 102 at equal distances, and then the wire is combined to part structure of the accessory such as its hanging rope 104 so that the accessory is indirectly illuminated by the emitting light of the LEDs. Besides, referring to FIG. 2, if a decoration 202 includes a transparent housing, an LED 200 may be received inside the transparent housing so that the emitting light of the LED 200 may pass through the transparent housing to achieve a lighting effect.

However, the design of coupling LEDs 100 to the wire 102 results in a spot-like lighting effect that fails to create evenly illumination. Thus, a large quantity of LEDs must be used to thoroughly brighten all parts of the accessory, and the cost would rise as a result. Further, the design of placing the LED 200 directly into the transparent housing of an decoration may illuminate only part of the accessory, where other parts such as the hanging rope and key chain are not illuminated, thus resulting in an inferior lighting effect.

### BRIEF SUMMERY OF THE INVENTION

An objective of the invention is to provide a decorative light-transmission device whose shape is adaptable in accordance with the shape of an object to be decorated for providing an evenly decorative lighting effect.

According to the invention, a decorative light-transmission device includes a light source and a flexible light-transmission structure positioned adjacent to the light source and combined with an object to be decorated. The light-transmission structure receives and radiates the light from the light source, and the light radiation of the light-transmission structure illuminates the object to be decorated. The light-transmission structure is a single wire or a bundle of multiple wires made of thermoplastic material.

Through the design of the invention, the light-transmission structure becomes a strip-like illuminant when receiving the light from the light source at on one end, and then the light radiating from the side surfaces of the strip-like illuminant brightens the object to be decorated. Since the illuminant is flexible to be bent into any shape in accordance with the shape of an object to be decorated, the light is evenly distributed on the object to be decorated to brighten each part of the object. Consequently, the invention has eliminated all the disadvantages of conventional illumination designs, such as the spot-like illumination, usage of a large quantity of LEDs, and inferior lighting effect.

### BRIEF DESCRIPTION OF THE DRAWINGS

FIG. 1 shows a schematic diagram illustrating a conventional design regarding how to illuminate an accessory.

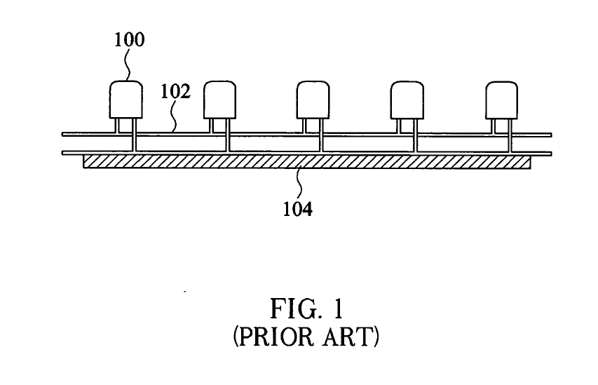

FIG. 2 shows a schematic diagram illustrating another conventional design regarding how to illuminate an accessory.

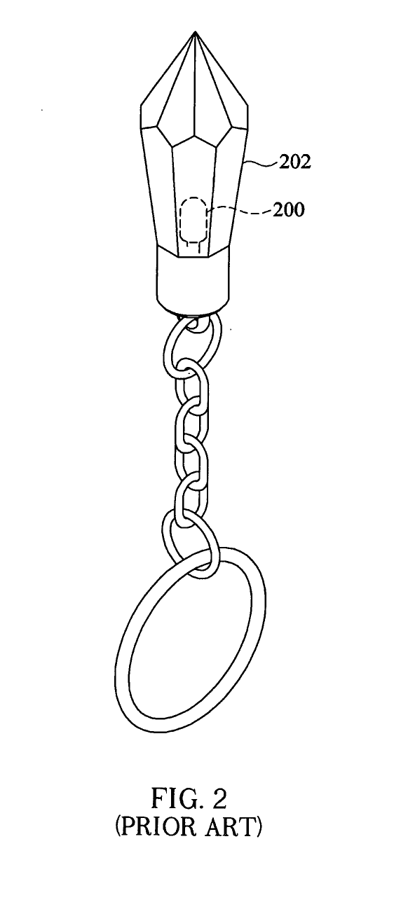

FIG. 3 shows a schematic diagram illustrating a decorative light-transmission device according to an embodiment of the invention

FIG. 4 shows a schematic diagram illustrating an arrangement of a light source and a light-transmission structure according to the invention.

FIG. 5 shows a schematic diagram illustrating an embodiment of the decorative light-transmission device of the invention in combination with an identification card.

FIG. 6 shows a schematic diagram illustrating an embodiment of the decorative light-transmission device of the invention in combination with a motorcycle lock.

FIG. 7A and FIG. 7B show schematic diagrams illustrating an embodiment of the decorative light-transmission device of the invention in combination with a textile product.

FIG. 8 shows a schematic diagram illustrating an embodiment of the decorative light-transmission device of the invention in combination with a decoration.

FIG. 9 shows a schematic diagram illustrating an embodiment of the decorative light-transmission device of the invention in combination with a bicycle.

### DETAILED DESCRIPTION OF THE INVENTION

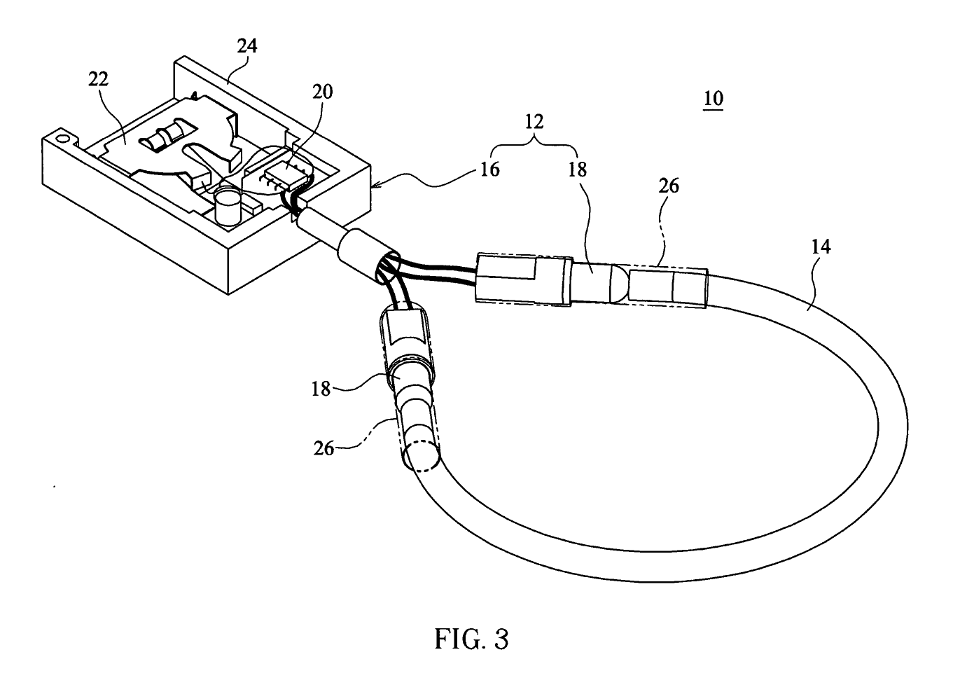

FIG. 3 is a schematic diagram illustrating a decorative light-transmission device 10 according to an embodiment of the invention.

Referring to FIG. 3, the light-transmission device 10 includes a light source 12 and a flexible light-transmission structure 14. The light source 12 includes a light-producing unit 16 and an illuminant such as a light emitting diode (LED) 18. The light-producing unit 16, which is used for controlling the emitting light of the LED 18, includes a circuit 20, a battery holder 22, and a casing 24 for receiving the circuit 20 and the battery holder 22. The light-transmission structure 14 may be made of a flexible plastic wire that can be bent into any shape and its transparency allows for radiating light received from the light source 12.

As shown in FIG. 3, the LED 18 is positioned to be in contact with one end surface of the light-transmission structure 14, and a thermoplastic tube 26 wraps the interface between them. As the thermoplastic tube 26 is heated, it shrinks to fix the LED 18 on the light-transmitting structure 14. When the light-producing unit 16 is enabled to turn on the LED 18, the light-transmission structure 14 receives the light from the LED 18 and radiates the light evenly to the outside. Hence, the flexible plastic wire becomes a strip-like illuminant and can be bent into any shape in accordance with the shape of an object to be decorated.

Through the design of the invention, the light-transmission structure 14 becomes a strip-like illuminant when receiving the light from the light source 12 at on one end, and then the light radiating from the side surfaces of the strip-like illuminant brightens the object to be decorated. Since the illuminant is flexible to be bent into any shape in accordance with the shape of an object to be decorated, the light is evenly distributed on the object to be decorated to brighten each part of the object. Consequently, all disadvantages of conventional illumination designs, such as the spot-like illumination, usage of a large quantity of LEDs and inferior lighting effect, have been eliminated.

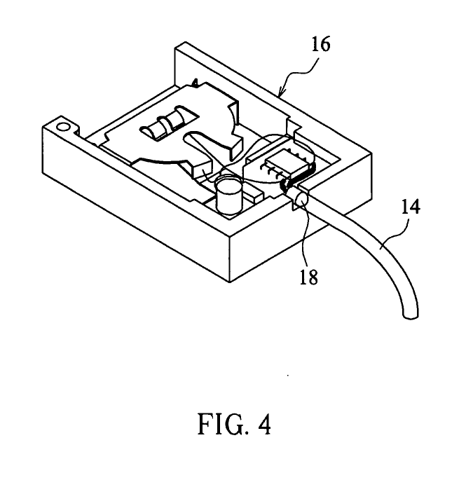

The way of combining the light source 12 and the light-transmission structure 14 is not limited to the method described above. For example, the LED 18 may be positioned away from the end of the light transmitting structure 14 at a distance, as long as the light from the light source 12 is fully received by the light-transmission structure 14. Alternatively, the LED 18 may be placed inside the light transmitting structure 14 as shown in FIG. 4 to ensure the reception of light.

Moreover, the number of the LED and its positioning are not limited. For example, if the light-transmission structure 14 is lengthy, two LEDs may be arranged on the two opposite ends of the light transmitting structure 14, as shown in FIG. 3. Of course, one LED for the light-transmission structure 14 is acceptable as in FIG. 4, as long as the single LED is capable of providing sufficient light. Further, there is no limitation on the selection of illuminants, as long as the light input is good; for example, a light bulb may be used instead of the LED.

The light-transmission structure may be either a single wire or a bundle of multiple wires, and its dimension and number are not limited. The light-transmission structure is made of a thermoplastic material with flexibility and high transparency, such as polycarbonate, polystyrene, polymethyl methacrylate, MMA styrene copolymer, thermoplastic polyurethane, and ethylene vinyl acetate.

The practical applications of the decorative light-transmission device according to the invention are described below.

According to the invention, the light-transmission structure may be mounted on the object to be decorated by adhering, wrapping, engaging, or sewing.

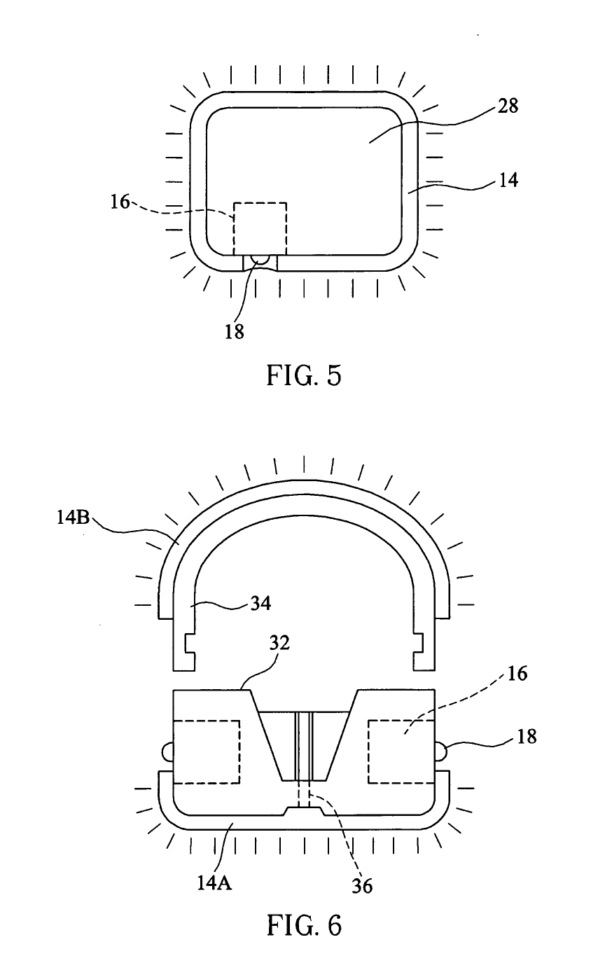

Referring to FIG. 5, the light-transmission device of the invention is combined with an identification card 28. The light-transmission structure 14 may be looped around the identification card 28 for decoration and identification under the circumstance of darkness.

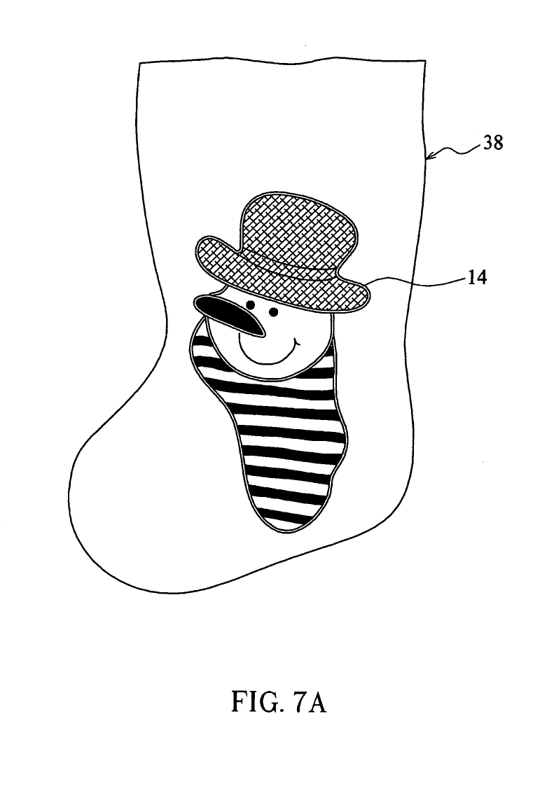

FIG. 6 shows a schematic view illustrating an embodiment of the invention, where the light-transmission device is applied to a motorcycle lock. As shown in FIG. 6, the light-transmission structure 14 is divided into two parts 14A and 14B fixed to a lock head 32 and a latch 34, respectively. When the lock head 32 and the latch 34 are coupled together, the LED 18 may illuminate both parts of the light-transmission structure 14A and 14B to provide a decorative lighting effect. Besides, the radiating light-transmission structure 14B may help users find the keyhole 36 when unlocking the lock in the dark.

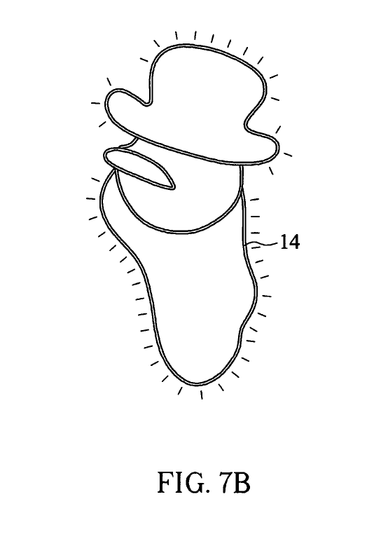

FIG. 7A and FIG. 7B illustrate an embodiment of the invention in connection with a textile product. Referring to FIG. 7A, the light-transmission structure 14 is sewed on a textile product, such as a sock 38, as an outline for the pattern on the textile product. The luminous light-transmission structure 14 not only functions as the outlines the pattern, it also creates a spectacular decorative effect on the textile product in the dark.

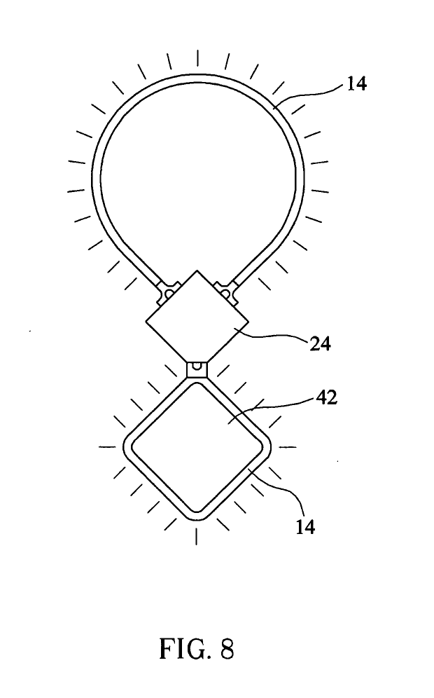

FIG. 8 illustrates an embodiment of the invention in connection with a decoration 42. In this embodiment, the figure of the casing 24 of the light-transmission device 10 is adapted to match the appearance of the decoration 42, and the light-transmission structure 14 may be provided as a hanging rope.

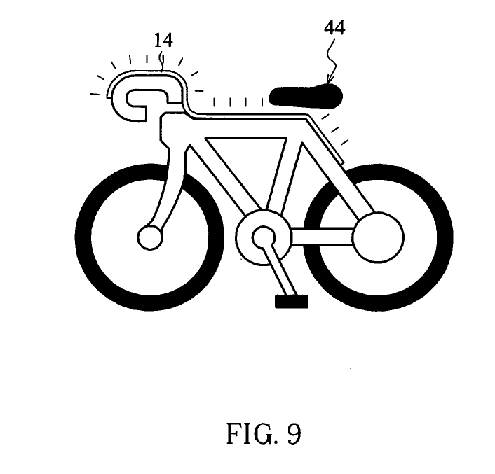

As shown in FIG. 9, the light-transmission structure 14 may be mounted on a bicycle 44 to function as a warning or an illumination tool during transportation.

It is seen that, from all embodiments described above, the light-transmission device of the invention is easy to be applied to any object to be decorated since it is able to distribute light evenly to each part of the object to be decorated.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A decorative light-transmission device, comprising:
a light source; and
a flexible light-transmission structure positioned adjacent to the light source and combined with an object to be decorated, wherein the light-transmission structure receives and radiates the light from the light source, and the light radiation of the light-transmission structure illuminates the object to be decorated.

2. The decorative light-transmission device as claimed in claim 1, wherein the light source comprises at least one illuminant and a light-producing unit for controlling the illuminant.

3. The decorative light-transmission device as claimed in claim 2, wherein the light-producing unit comprises a circuit, a battery holder, and a casing for receiving the circuit and the battery holder.

4. The decorative light-transmission device as claimed in claim 2, wherein the illuminant is a light emitting diode or a light bulb.

5. The decorative light-transmission device as claimed in claim 2, wherein the illuminant is in contact with one end of the light-transmission structure.

6. The decorative light-transmission device as claimed in claim 2, wherein the illuminant is placed inside the light-transmission structure.

7. The decorative light-transmission device as claimed in claim 2, further comprising a thermoplastic cover wrapped around the interface between the illuminant and the light-transmission structure.

8. The decorative light-transmission device as claimed in claim 1, wherein the light-transmission structure comprises a single wire or a bundle of multiple wires.

9. The decorative light-transmission device as claimed in claim 1, wherein the light-transmission structure is made of transparent thermoplastic material.

10. The decorative light-transmission device as claimed in claim 1, wherein the material of the light-transmission structure is selected from a group consisting of polycarbonate, polystyrene, polymethyl methacrylate, MMA styrene copolymer, thermoplastic polyurethane, and ethylene vinyl acetate.

11. The decorative light-transmission device as claimed in claim 1, wherein the light-transmission structure is mounted on the object to be decorated by wrapping, adhering, sewing, or engaging.

12. The decorative light-transmission device as claimed in claim 1, wherein the object to be decorated is a textile product, an identification card, a motorcycle lock, a decoration, or a bicycle.

13. A decorative light-transmission device, comprising:
a light source comprising at least one illuminant and a light-producing unit for controlling the illuminant; and
a flexible light-transmission wire for receiving the emitting light of the illuminant, wherein the light-transmission wire is bent to a shape in accordance with the shape of an object to be decorated and is fixed thereto, so that the light radiation of the light-transmission wire provides the object to be decorated with an evenly distributed lighting effect.

14. The decorative light-transmission device as claimed in claim 13, wherein the light-producing unit comprises a circuit, a battery holder, and a casing for receiving the circuit and the battery holder.

15. The decorative light-transmission device as claimed in claim 13, wherein the illuminant is a light emitting diode or a light bulb.

16. The decorative light-transmission device as claimed in claim 13, wherein the illuminant is in contact with the surface of the adjacent light-transmission wire.

17. The decorative light-transmission device as claimed in claim 13, wherein the illuminant is placed inside the light-transmission wire.

18. The decorative light-transmission device as claimed in claim 13, further comprising a thermoplastic cover wrapped around the interface between the illuminant and the light-transmission structure.

19. The decorative light-transmission device as claimed in claim 13, wherein the light-transmission structure is made of a transparent thermoplastic material.

20. The decorative light-transmission device as claimed in claim 13, wherein the material of the light-transmission structure is selected from a group consisting of polycarbonate, polystyrene, polymethyl methacrylate, MMA styrene copolymer, thermoplastic polyurethane, and ethylene vinyl acetate.
